(19) United States
(12) Patent Application Publication
(10) Pub. No.: US 2025/0309224 A1
(43) Pub. Date: Oct. 2, 2025

(54) COATING DEVICE, COATING METHOD, METHOD OF MANUFACTURING POSITIVE ELECTRODE, AND METHOD OF MANUFACTURING SOLID-STATE BATTERY

(71) Applicant: HONDA MOTOR CO., LTD., Tokyo (JP)

(72) Inventors: Shuga IKEDA, Saitama (JP); Tsubasa HORIE, Saitama (JP); Satoshi YONEZAWA, Saitama (JP); Shohei YOSHIDA, Saitama (JP); Hiroshi SAKAI, Saitama (JP); Tatsuya HASHIMOTO, Saitama (JP); Shigeto AKAHORI, Saitama (JP); Tsuneyoshi KAMADA, Saitama (JP); Kohei MATSUMOTO, Saitama (JP)

(21) Appl. No.: 19/023,351

(22) Filed: Jan. 16, 2025

(30) Foreign Application Priority Data
Mar. 29, 2024 (JP) 2024-057704

(51) Int. Cl. H01M 4/04; H01M 4/02; H01M 10/052; H01M 10/058

(52) U.S. Cl. CPC H01M 4/0416; H01M 4/0404; H01M 10/052; H01M 10/058; H01M 2004/028

(57) ABSTRACT

There is provided a coating device including: a conveyer that continuously conveys a sheet-shaped material-to-be-coated; a first die head that intermittently discharges a first slurry toward a first surface region of the material-to-be-coated being continuously conveyed, to discontinuously form a first coated section; and a first gas ejector that ejects a first gas toward a terminal end of the first slurry being intermittently discharged, wherein the first die head has a slit-shaped first discharge port that discharges the first slurry in a direction substantially perpendicular to a convey direction of the material-to-be-coated in the first surface region and that extends in a width direction of the conveyer, the first gas ejector has: a slit-shaped first ejection port that ejects the first gas in a direction substantially parallel to the convey direction of the material-to-be-coated in the first surface region and that extends in the width direction of the conveyer.

This application is based on and claims the benefit of priority from Japanese Patent Application No. 2024-057704, filed on 29 Mar. 2024, the content of which is incorporated herein by reference.

### BACKGROUND OF THE INVENTION

### Field of the Invention

The present invention relates to a coating device, a coating method, a method of manufacturing a positive electrode, and a method of manufacturing a solid-state battery.

### Related Art

In recent years, research and development pertaining to batteries that contribute to improving energy efficiency has been carried out in order to be able to ensure many people have access to sustainable, advanced energy that is affordable and reliable.

A battery includes a positive electrode having a positive electrode current collector and a positive electrode mixture layer, a negative electrode having a negative electrode current collector and a negative electrode mixture layer, and an electrolyte, and a coating device is used when the battery is manufactured.

Patent Document 1 describes a coating device that applies a slurry to a surface of a continuously moving sheet-shaped member. Here, the coating device includes a die head that includes a slit-shaped discharge port facing a backup roll that supports the sheet-shaped member. The coating device further includes a first gas nozzle that is disposed on a lateral side of the sheet-shaped member at a position immediately beyond the discharge port, and oriented so as to supply pressurized gas, in a direction along the width direction, to a width end edge of a slurry layer applied to the sheet-shaped member. In addition, the coating device includes a second gas nozzle that is disposed downstream of the first gas nozzle and above the backup roll to face the width ends of the slurry layer, and oriented so as to supply pressurized gas in a direction perpendicular to the surface of the slurry layer.
Patent Document 1: Japanese Unexamined Patent Application, Publication No. 2017-170312

### SUMMARY OF THE INVENTION

However, in the coating device described in Patent Document 1, when the slurry is intermittently discharged from the die head, dragging occurs at the terminal end of the discharged slurry.

An object of the present invention is to provide a coating device and a coating method capable of preventing dragging at a terminal end of a discharged slurry even if the slurry is intermittently discharged from a die head.
(1) A coating device including: a conveyer that continuously conveys a sheet-shaped material-to-be-coated; a first die head that intermittently discharges a first slurry toward a first surface region of the material-to-be-coated being continuously conveyed, to discontinuously form a first coated section; and a first gas ejector that ejects a first gas toward a terminal end of the first slurry being intermittently discharged. The first die head has a slit-shaped first discharge port that discharges the first slurry in a direction substantially perpendicular to a convey direction of the material-to-be-coated in the first surface region and that extends in a width direction of the conveyer, the first gas ejector has: a slit-shaped first ejection port that ejects the first gas in a direction substantially parallel to the convey direction of the material-to-be-coated in the first surface region and that extends in the width direction of the conveyer; and a first main body and a second main body that extend in the width direction of the conveyer, the first ejection port is formed between the first main body and the second main body, the first gas ejector is disposed such that: the first ejection port is in a vicinity of the first discharge port; and the first main body is disposed close to the first die head and the second main body is disposed close to the conveyer, and the first main body extends closer to the first die head than the second main body does.
(2) The coating device according to (1), wherein the first gas ejector further has a plurality of first supply ports through which the first gas is supplied, and a first gas junction section that is connected to the plurality of first supply ports and the first ejection port and that merges the first gas supplied from the plurality of first supply ports, and the plurality of first supply ports is disposed in a width direction of the conveyer.
(3) The coating device according to (2), wherein the first supply ports and the first gas junction each have a dimension in a thickness direction larger than the first ejection port, and the first gas junction has an inclined surface that is inclined toward the first ejection port.
(4) The coating device according to (2) or (3), wherein the first main body is formed with a groove-shaped section that extends in the width direction of the conveyer, the second main body is a plate-shaped member, and the first gas junction is formed between the first main body and the second main body.
(5) The coating device according to any one of (1) to (4), further including a second die head that intermittently discharges a second slurry toward a second surface region of the material-to-be-coated being continuously conveyed, to discontinuously form a second coated section. The second surface region is located downstream of the first surface region, the second coated section is formed in a region where the first coated section is not formed, and the second die head has a slit-shaped second discharge port that discharges the second slurry in a direction substantially perpendicular to the convey direction of the material-to-be-coated in the second surface region and that extends in the width direction of the conveyer.
(6) The coating device according to (5), further including a second gas ejector that ejects a second gas toward a terminal end of the second slurry being intermittently discharged, wherein the second gas ejector has: a slit-shaped second ejection port that ejects the second gas in a direction substantially parallel to the convey direction of the material-to-be-coated in the second surface region and that extends in the width direction of the conveyer; and a third main body and a fourth main body that extend in the width direction of the conveyer, the second ejection port is formed between the third main body and the fourth main body, the second gas ejector is disposed such that: the second ejection port is in a vicinity of the second discharge port; and the third main body is disposed close to the second die head and the fourth main body is disposed close to the conveyer, and the third main body extends closer to the second die head than the fourth main body does.
(7) A coating method using the coating device according to any one of (1) to (4), the method including: continuously conveying the sheet-shaped material-to-be-coated while intermittently discharging the first slurry from the first die head toward the first surface region of the material-to-be-coated being continuously conveyed, to discontinuously form the first coated section.
(8) A coating method using the coating device according to (5) or (6), the method including:
   continuously conveying the sheet-shaped material-to-be-coated while intermittently discharging the first slurry from the first die head toward the first surface region of the material-to-be-coated being continuously conveyed, to discontinuously form the first coated section; and intermittently discharging the second slurry from the second die head toward the second surface region of the material-to-be-coated being continuously conveyed, to discontinuously form the second coated section.
(9) A method of manufacturing a positive electrode through the coating method according to (8), the method including: using a positive electrode current collector as the material-to-be-coated; using a slurry for a positive electrode mixture layer as the first slurry; and using a slurry for an insulating layer as the second slurry.
(10) A method of manufacturing a solid-state battery, the method including obtaining a positive electrode through the method of manufacturing a positive electrode according to (9).

According to the present invention, it is possible to provide a coating device and a coating method capable of preventing dragging at a terminal end of a discharged slurry even if the slurry is intermittently discharged from a die head.

### BRIEF DESCRIPTION OF THE DRAWINGS

FIG. 1 is a perspective view showing a coating device according to one embodiment of the present invention;

FIG. 2 is a cross-sectional view showing the coating device in FIG. 1;

FIG. 3 is a top view describing a first coated section;

FIG. 4 is a top view showing dragging at a terminal end of a first slurry;

FIG. 5 is an enlarged perspective view of a first air nozzle in FIG. 2;

FIG. 6 is an enlarged cross-sectional view of the first air nozzle in FIG. 2;

FIG. 7 is a cross-sectional view showing the coating device in FIG. 1;

FIG. 8 is a top view describing a second coated section; and

FIG. 9 is an enlarged cross-sectional view of a second air nozzle in FIG. 2.

### DETAILED DESCRIPTION OF THE INVENTION

Hereinafter, an embodiment of the present invention will be described with reference to the drawings.

### [Coating Device]

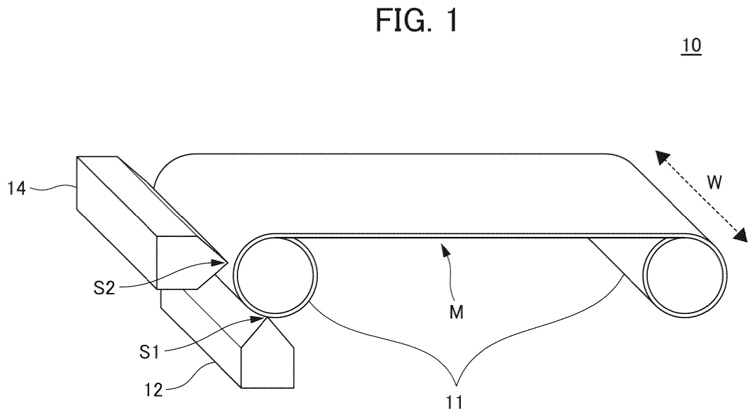

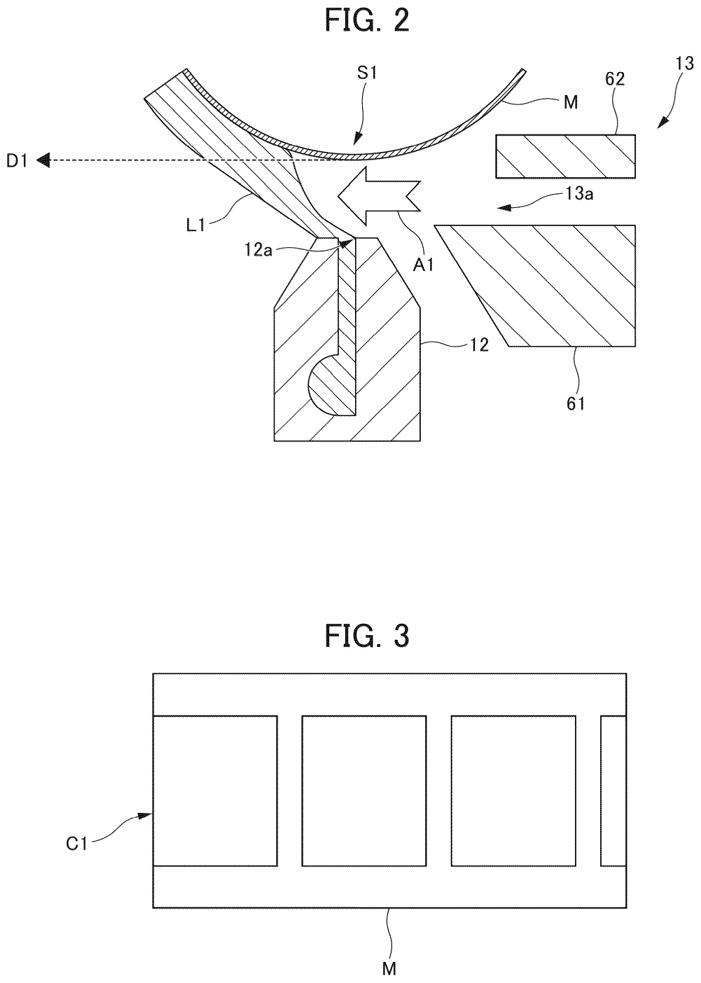

As shown in FIGS. 1 and 2, a coating device 10 includes: a conveyance roller 11 that is a conveyer for continuously conveying a sheet-shaped material-to-be-coated M; and a first die head 12 that intermittently discharges a first slurry L1 toward a first surface region S1 of the material-to-be-coated M being continuously conveyed, to discontinuously form a first coated section C1 (see FIG. 3). The coating device 10 further includes a first air nozzle 13 that is a first gas ejector for ejecting a first gas A1 toward the terminal end of the intermittently discharged first slurry L1. This prevents dragging at the terminal end of the first slurry L1 discharged from the first die head 12, resulting in an improved shape accuracy of the first coated section C1. Here, the first die head 12 discharges the first slurry L1 in a direction substantially perpendicular to the convey direction D1 of the material-to-be-coated M in the first surface region S1. The first air nozzle 13 ejects the first gas A1 in a direction substantially parallel to the convey direction D1 of the material-to-be-coated M in the first surface region S1.

In order to eject the first gas A1 toward the terminal end of the intermittently discharged first slurry L1, the timing of ejecting the first gas A1 just needs to be adjusted based on the coating speed of the first slurry L1 (the conveying speed of the material-to-be-coated M), the flow rate of the first gas A1, and the timing of stopping the discharge of the first slurry L1.

At this time, the coating speed of the first slurry L1 (the conveying speed of the material-to-be-coated M) is not particularly limited, but is, for example, 10 m/min to 60 m/min. In addition, the ejection pressure of the first gas A1 is not particularly limited, but is, for example, 10 kPa to 700 kPa. Furthermore, the viscosity of the first slurry L1 at 25° C. is not particularly limited, but is, for example, 1000 mPa·s to 3000 mPa·s.

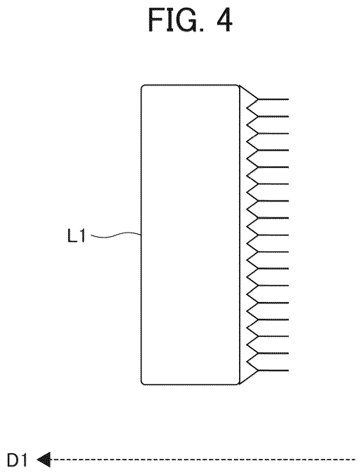

If the first gas A1 is not ejected toward the terminal end of the intermittently discharged first slurry L1, dragging will occur at the terminal end of the first slurry L1 discharged from the first die head 12 (see FIG. 4).

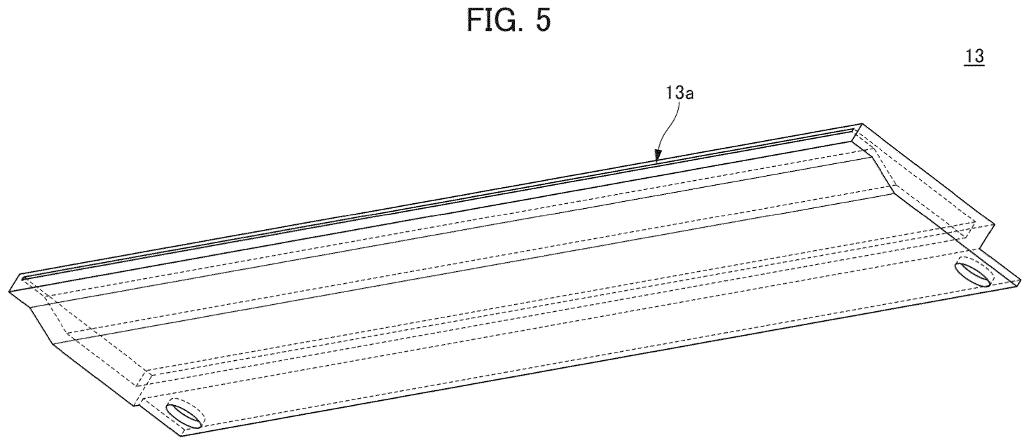

The first die head 12 discharges the first slurry L1 and has a slit-shaped first discharge port 12a extending in the width direction W of the conveyance roller 11 (material-to-be-coated M). The first air nozzle 13 ejects the first gas A1 and has a slit-shaped first ejection port 13a extending in the width direction W of the conveyance roller 11 (see FIG. 5). This further improves the shape accuracy of the first coated section C1. At this time, the first ejection port 13a is disposed in the vicinity of the first discharge port 12a. The width of the first ejection port 13a is not particularly limited, but is, for example, 500 mm to 700 mm.

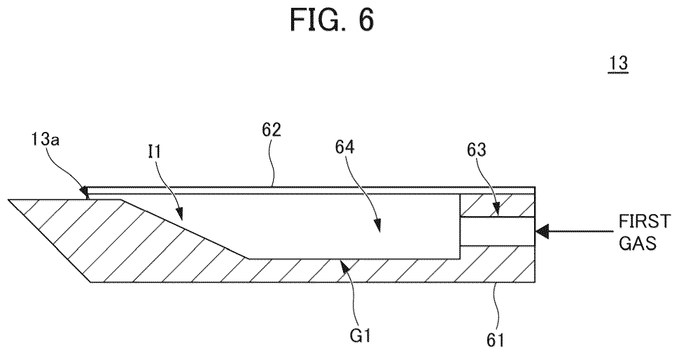

As shown in FIG. 6, the first air nozzle 13 has a first main body 61 and a second main body 62 that extend in the width direction W of the conveyance roller 11. The first ejection port 13a is formed between the first main body 61 and the second main body 62. At this time, the first main body 61 is disposed close to the first die head 12 and the second main body 62 is disposed close to the conveyance roller 11 (material-to-be-coated M), and the first main body 61 extends closer to the first die head 12 than the second main body 62 does (see FIG. 2). As a result, the first air nozzle 13 can be brought closer to the first discharge port 12a of the first die head 12 to efficiently eject the first gas A1.

Furthermore, since the first main body 61 extends closer to the first die head 12 than the second main body 62 does, the first gas A1 is guided toward the terminal end of the intermittently discharged first slurry L1, and the first air nozzle 13 does not interfere with the conveyance roller 11.

The first air nozzle 13 further has: a plurality of first supply ports 63 through which the first gas A1 is supplied from a supply source (e.g., a tank) of the first gas A1; and a first gas junction 64 that is connected to the plurality of first supply ports 63 and the first ejection port 13a, and that merges the first gas A1 supplied from the plurality of first supply ports 63. At this time, the plurality of first supply ports 63 are formed in the width direction W (depth direction in the figure) of the conveyance roller 11.

The first supply ports 63 and the first gas junction 64 have a dimension in the thickness direction larger than the first ejection port 13a. The first gas junction 64 has an inclined surface I1 that is inclined toward the first ejection port 13a. In other words, the first main body 61 is formed with a groove-shaped section G1 extending in the width direction W of the conveyance roller 11, the second main body 62 is a plate-shaped member, and the first gas junction 64 is formed between the first main body 61 and the second main body 62. At this time, the inclination angle of the inclined surface I1 is not particularly limited, but is, for example, 10° or more and 80° or less.

The first die head 12 is not particularly limited as long it is capable of intermittently discharging the first slurry L1 to discontinuously form the first coated section C1, and any known die head can be used.

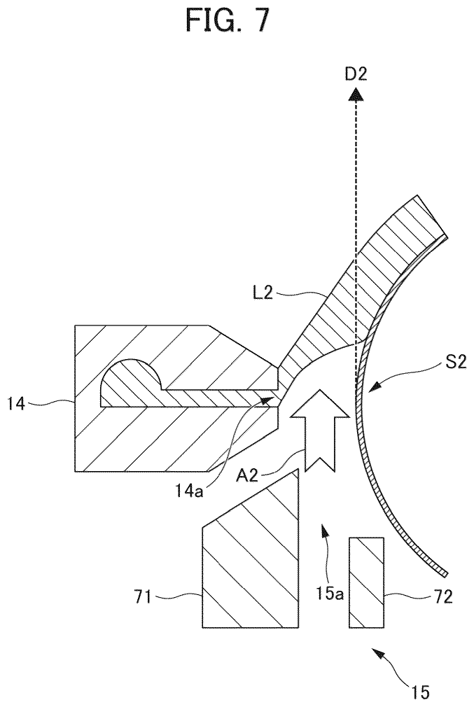

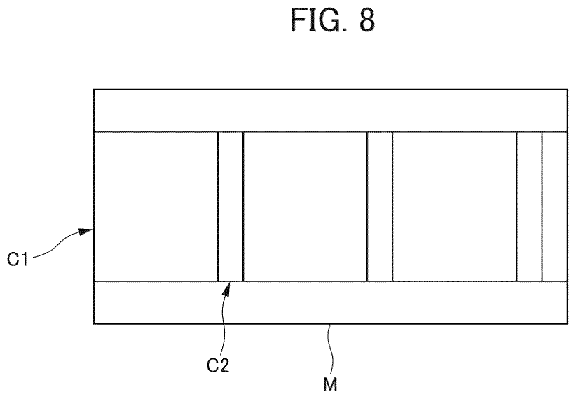

As shown in FIG. 7, the coating device 10 further includes a second die head 14. The second die head 14 intermittently discharges the second slurry L2 toward the second surface region S2 of the material-to-be-coated M being continuously conveyed, to discontinuously form the second coated section C2 (see FIG. 8). At this time, the second surface region S2 is located downstream of the first surface region S1, and the second coated section C2 is formed in a region where the first coated section C1 is not formed. As a result, since the shape accuracy of the first coated section C1 is high, the shape accuracy of the second coated section C2 is also high. Here, the second die head 14 discharges the second slurry L2 in a direction substantially perpendicular to the convey direction D2 of the material-to-be-coated M in the second surface region S2.

The coating device 10 further includes a second air nozzle 15 that is a second gas ejector for ejecting the second gas A2 toward the terminal end of the intermittently discharged second slurry L2. This prevents dragging at the terminal end of the second slurry L2 discharged from the second die head 14, resulting in an improved shape accuracy of the second coated section C2. Here, the second air nozzle 15 ejects the second gas A2 in a direction substantially parallel to the convey direction D2 of the material-to-be-coated M in the second surface region S2.

In order to eject the second gas A2 toward the terminal end of the intermittently discharged second slurry L2, the timing of ejecting the second gas A2 just needs to be adjusted based on the coating speed of the second slurry L2 (the conveying speed of the material-to-be-coated M), the flow rate of the second gas A2, and the timing of stopping the discharge of the second slurry L2.

At this time, the coating speed of the second slurry L2 (the conveying speed of the material-to-be-coated M) is not particularly limited, but is, for example, 10 m/min or more and 60 m/min or less. The ejection pressure of the second gas A2 is not particularly limited, but is, for example, 10 kPa or more and 700 kPa or less. The viscosity of the second slurry L2 at 25° C. is not particularly limited, but is, for example, 1000 mPa·s or more and 3000 mPa·s or less.

Similarly to the first die head 12, the second die head 14 discharges the second slurry L2 and has a slit-shaped second discharge port 14a extending in the width direction W of the conveyance roller 11. Similarly to the first air nozzle 13, the second air nozzle 15 ejects the second gas A2 and has a slit-shaped second ejection port 15a extending in the width direction W of the material-to-be-coated M. This further improves the shape accuracy of the second coated section C2. At this time, the second ejection port 15a is disposed in the vicinity of the second discharge port 14a.

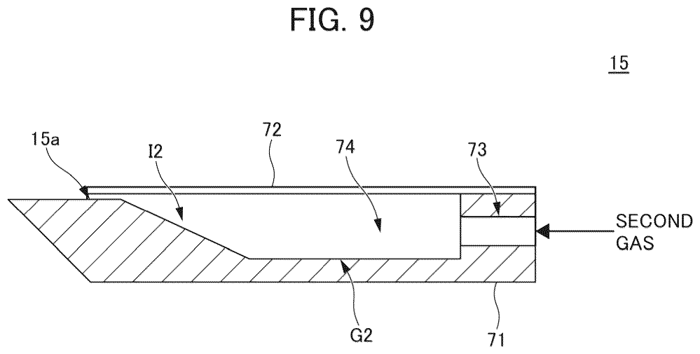

As shown in FIG. 9, the second air nozzle 15 has a third main body 71 and a fourth main body 72 that extend in the width direction W of the conveyance roller 11. The second ejection port 15a is formed between the third main body 71 and the fourth main body 72. At this time, the third main body 71 is disposed close to the second die head 14 and the fourth main body 72 is disposed close to the conveyance roller 11 (material-to-be-coated M), and the third main body 71 extends closer to the second die head 14 than the fourth main body 72 does (see FIG. 7). As a result, the second air nozzle 15 can be brought closer to the second discharge port 14a of the first die head 14 to efficiently eject the second gas A2. Furthermore, since the third main body 71 extends closer to the second die head 14 than the fourth main body 72 does, the second gas A2 is guided toward the terminal end of the intermittently discharged second slurry L2, and the second air nozzle 15 does not interfere with the conveyance roller 11.

The second air nozzle 15 further has: a plurality of second supply ports 73 through which the second gas A2 is supplied from a supply source (e.g., a tank) of the second gas A2; and a second gas junction 74 that is connected to the plurality of second supply ports 73 and the second ejection port 15a, and that merges the second gas A2 supplied from the plurality of second supply ports 73. At this time, the plurality of second supply ports 73 are formed in the width direction W (depth direction in the figure) of the conveyance roller 11.

The second supply ports 73 and the second gas junction 74 have a dimension in the thickness direction larger than the second ejection port 15a. The second gas junction 74 has an inclined surface 12 that inclines toward the second ejection port 15a. In other words, the third main body 71 is formed with a groove-shaped section G2 extending in the width direction W of the conveyance roller 11, the fourth main body 72 is a plate-shaped member, and the second gas junction 74 is formed between the third main body 71 and the fourth main body 72. At this time, the inclination angle of the inclined surface I2 is not particularly limited, but is, for example, 10° or more and 80° or less.

The second die head 14 is not particularly limited as long it is capable of intermittently discharging the second slurry L2 to discontinuously form the second coated section C2, and any known die head can be used.

Note that, as needed, the second air nozzle 15 may be omitted, and the second die head 14 may further be omitted.

### [Coating Method]

A coating method of this embodiment includes a step of continuously conveying the sheet-shaped material-to-be-coated M while intermittently discharging a first slurry L1 from a first die head 12 toward a first surface region S1 of the material-to-be-coated M being continuously conveyed, to discontinuously form a first coated section C1. The coating method can be implemented using the coating device 10. At this time, a first gas A1 is ejected toward the terminal end of the intermittently discharged first slurry L1. This prevents dragging at the terminal end of the first slurry L1 discharged from the first die head 12, resulting in an improved shape accuracy of the first coated section C1. In addition, the first slurry L1 is discharged in a direction substantially perpendicular to the convey direction D1 of the material-to-be-coated M in the first surface region S1, and the first gas A1 is ejected in a direction substantially parallel to the convey direction D1 of the material-to-be-coated M in the first surface region S1.

The coating method of this embodiment may further include a step of intermittently discharging the second slurry L2 from the second die head 14 toward the second surface region S2 of the material-to-be-coated M being continuously conveyed, to discontinuously form the second coated section C2. At this time, the second surface region S2 is located downstream of the first surface region S1, and the second coated section C2 is formed in a region where the first coated section C1 is not formed. As a result, since the shape accuracy of the first coated section C1 is high, the shape accuracy of the second coated section C2 is also high. Here, the second slurry L2 is discharged in a direction substantially perpendicular to the convey direction D2 of the material-to-be-coated M in the second surface region S2.

The coating method of this embodiment may eject the second gas A2 toward the terminal end of the intermittently discharged second slurry L2. At this time, the second gas A2 is ejected in a direction substantially parallel to the convey direction D2 of the material-to-be-coated M in the second surface region S2. This prevents dragging at the terminal end of the second slurry L2 discharged from the second die head 14, resulting in an improved shape accuracy of the second coated section C2. Here, the second gas A2 is ejected in a direction substantially parallel to the convey direction D2 of the material-to-be-coated M in the second surface region S2.

The coating method of this embodiment may further include a step of heating and drying the material-to-be-coated M on which the first coated section C1 (and the second coated section C2) has (have) been formed.

The coating method of this embodiment may be applied, for example, to the manufacture of positive electrodes, negative electrodes, and solid electrolyte layers that constitute batteries.

### [Method of Manufacturing a Positive Electrode]

A method of manufacturing a positive electrode of this embodiment is a method of manufacturing a positive electrode through the coating method of this embodiment. Here, the material-to-be-coated M is a positive electrode current collector, the first slurry is a slurry for a positive electrode mixture layer, and the second slurry is a slurry for an insulating layer. This provides a positive electrode having high shape accuracy of the positive electrode mixture layer and the insulating layer.

The positive electrode current collector is not particularly limited, but may be, for example, aluminum foil.

The slurry for a positive electrode mixture layer includes, for example, a positive electrode active material.

The positive electrode active material is not particularly limited, but may be, for example, lithium iron phosphate.

The slurry for an insulating layer includes an insulating material. The insulating material is not particularly limited, but may be, for example, alumina.

The method of manufacturing a positive electrode of this embodiment may further include a step of continuously forming a second insulating layer on both sides of the positive electrode mixture layer in the width direction W. At this time, the second insulating layer may also be formed when the positive electrode mixture layer is formed.

### [Method of Manufacturing a Solid-State Battery]

A method of manufacturing a solid-state battery of this embodiment includes a step of obtaining a positive electrode through the method of manufacturing a positive electrode of this embodiment. This prevents short circuits in the solid-state battery.

The method of manufacturing a solid-state battery of this embodiment may further include a step of forming a solid electrolyte layer on the positive electrode mixture layer to form a positive electrode-solid electrolyte layer laminate.

The solid-state battery is not particularly limited, but may be, for example, an all-solid-state lithium metal battery. The all-solid-state lithium metal battery will be described below.

The all-solid-state lithium metal battery includes a negative electrode having a negative electrode current collector and a lithium metal layer, a positive electrode having a positive electrode current collector and a positive electrode mixture layer, and a solid electrolyte layer.

The negative electrode current collector is not particularly limited, but may be, for example, copper foil.

The positive electrode mixture layer includes a positive electrode active material, and may further include a solid electrolyte, a conductive additive, a binder, etc. The positive electrode active material is not particularly limited as long it is capable of absorbing and releasing lithium ions, but may be, for example, a lithium nickel cobalt manganese composite oxide. The solid electrolyte is not particularly limited if it has lithium ion conductivity, but may be, for example, an oxide-based electrolyte or a sulfide-based electrolyte. The conductive additive is not particularly limited if it has electronic conductivity, but may be, for example, carbon black. The binder is not particularly limited as long it is capable of improving the binding property, but may be, for example, styrene butadiene rubber.

The positive electrode current collector is not particularly limited, but may be, for example, aluminum foil.

The solid electrolyte layer includes a solid electrolyte, and may further include a binder, etc. The solid electrolyte is not particularly limited if it has lithium ion conductivity, but may be, for example, an inorganic solid electrolyte such as an oxide-based electrolyte or a sulfide-based electrolyte. The binder is not particularly limited as long it is capable of improving the binding property, but may be, for example, styrene butadiene rubber.

An intermediate layer having a function of uniformly precipitating lithium metal may be formed between the negative electrode and the solid electrolyte layer. This stabilizes the interface between the intermediate layer and the solid electrolyte layer. In this case, the all-solid-state lithium metal battery may be an anode-free battery in which the lithium metal layer is not formed at the time of the first charge. In the anode-free battery, the lithium metal layer is formed after the first charge and discharge.

The intermediate layer contains a metal that can be alloyed with lithium and an amorphous carbon, and may further contain a binder, etc. The metal that can be alloyed with lithium and the amorphous carbon are preferably in nanoparticles. Examples of metals that can be alloyed with lithium include tin (Sn), silicon (Si), zinc (Zn), magnesium (Mg), gold (Au), platinum (Pt), palladium (Pd), silver (Ag), aluminum (Al), bismuth (Bi), and antimony (Sb). Examples of amorphous carbon include carbon blacks such as acetylene black, furnace black, and ketjen black, coke, and activated carbon. The amorphous carbon may be graphitizable carbon (soft carbon), non-graphitizable carbon (hard carbon), CNT (carbon nanotube), fullerene, or graphene. The binder is not particularly limited as long it can improve the binding property, but may be, for example, polyvinylidene fluoride (PVDF).

The above describes the embodiments of the present invention, but the present invention is not limited to the above embodiments, and the above embodiments may be modified as appropriate within the scope of the present invention.

### EXAMPLES

Hereinafter, examples of the present invention are described, but the present invention is not limited to the examples.

### Example 1

A coating device 10 was used to discontinuously form a positive electrode mixture layer on a positive electrode current collector. Specifically, an aluminum foil, which was the material-to-be-coated M, was continuously conveyed while a slurry for a positive electrode mixture layer, which was the first slurry L1, was intermittently discharged from the first die head 12 toward the first surface region S1 of the material-to-be-coated M being continuously conveyed, to discontinuously form a positive electrode mixture layer, which was the first coated section C1. At this time, the first gas A1 was ejected from the first air nozzle 13 toward the terminal end of the intermittently discharged first slurry L1. Here, the slurry for a positive electrode mixture layer, which was used, was a slurry that: contained lithium iron phosphate as a positive electrode active material; and had a viscosity at 25° C. of 2000 mPa's to 2500 mPa·s. The first air nozzle 13, which was used, was an air nozzle having a first ejection port 13a with a width of 1 mm. The coating speed of the first slurry L1 (the conveying speed of the material-to-be-coated M) was set to 10 m/min, and the ejection pressure of the first gas A1 was set to 500 kPa.

### Comparative Example 1

A positive electrode mixture layer was discontinuously formed on a positive electrode current collector in the same manner as in Example 1, except that the first gas A1 was not ejected from the first air nozzle 13 toward the terminal end of the intermittently discharged first slurry L1.

### Comparative Example 2

A positive electrode mixture layer was discontinuously formed on a positive electrode current collector in the same manner as in Example 1, except that an air knife manufactured by Blovac Ltd. was used instead of the first air nozzle 13.

### [Dragging]

The dragging at the terminal end of the discharged first slurry L1 was measured.

Table 1 shows the evaluation results of the dragging.

TABLE 1

| | | Comparative | Comparative |
|---|---|---|---|
| | Example 1 | Example 1 | Example2 |
| Dragging [mm] | 0.5 | 8 | 3 |

Table 1 shows that the dragging is smaller in Example 1. In contrast, in Comparative Example 1, the first gas A1 has not been ejected from the first air nozzle 13 toward the terminal end of the intermittently discharged first slurry L1, so that dragging is large at the terminal end of the discharged first slurry L1. In Comparative Example 2, the first gas A1 was ejected, so that the dragging was smaller than in Comparative Example 1. However, the air knife does not have the first main body 61 and the second main body 62 and it cannot be brought close to the first discharge port 12a of the first die head 12, so that the first gas A1 cannot be ejected efficiently. As a result, the dragging is larger than in Example 1.

### EXPLANATION OF REFERENCE NUMERALS

10 coating device
11 conveyance roller
12 first die head
12a first discharge port
13 first air nozzle
13a first ejection port
14 second die head
14a second discharge port
15 second air nozzle
15a second ejection port
61 first main body
62 second main body
63 first supply port
64 first gas junction
71 third main body
72 fourth main body
73 second supply port
74 second gas junction
A1 first gas
A2 second gas
C1 first coated section
C2 second coated section
D1, D2 convey direction
G1, G2 groove-shaped section
I1, 12 inclined surface
L1 first slurry
L2 second slurry
M material-to-be-coated
S1 first surface region
S2 second surface region
W width direction

What is claimed is:

1. A coating device comprising:
a conveyer that continuously conveys a sheet-shaped material-to-be-coated;
a first die head that intermittently discharges a first slurry toward a first surface region of the material-to-be-coated being continuously conveyed, to discontinuously form a first coated section; and
a first gas ejector that ejects a first gas toward a terminal end of the first slurry being intermittently discharged, wherein
the first die head has a slit-shaped first discharge port that discharges the first slurry in a direction substantially perpendicular to a convey direction of the material-to-be-coated in the first surface region and that extends in a width direction of the conveyer,
the first gas ejector has: a slit-shaped first ejection port that ejects the first gas in a direction substantially parallel to the convey direction of the material-to-be-coated in the first surface region and that extends in the width direction of the conveyer; and a first main body and a second main body that extend in the width direction of the conveyer, the first ejection port is formed between the first main body and the second main body,
the first gas ejector is disposed such that: the first ejection port is in a vicinity of the first discharge port; and the first main body is disposed close to the first die head and the second main body is disposed close to the conveyer, and
the first main body extends closer to the first die head than the second main body does.

2. The coating device according to claim 1, wherein
the first gas ejector further has a plurality of first supply ports through which the first gas is supplied, and a first gas junction section that is connected to the plurality of first supply ports and the first ejection port and that merges the first gas supplied from the plurality of first supply ports, and
the plurality of first supply ports is disposed in the width direction of the conveyer.

3. The coating device according to claim 2, wherein
the first supply ports and the first gas junction each have a dimension in a thickness direction larger than the first ejection port, and
the first gas junction has an inclined surface that is inclined toward the first ejection port.

4. The coating device according to claim 2, wherein
the first main body is formed with a groove-shaped section that extends in the width direction of the conveyer,
the second main body is a plate-shaped member, and
the first gas junction is formed between the first main body and the second main body.

5. The coating device according to claim 1, further comprising:
a second die head that intermittently discharges a second slurry toward a second surface region of the material-to-be-coated being continuously conveyed, to discontinuously form a second coated section, wherein
the second surface region is located downstream of the first surface region,
the second coated section is formed in a region where the first coated section is not formed, and
the second die head has a slit-shaped second discharge port that discharges the second slurry in a direction substantially perpendicular to the convey direction of the material-to-be-coated in the second surface region and that extends in the width direction of the conveyer.

6. The coating device according to claim 5, further comprising:
a second gas ejector that ejects a second gas toward a terminal end of the second slurry being intermittently discharged, wherein
the second gas ejector has: a slit-shaped second ejection port that ejects the second gas in a direction substantially parallel to the convey direction of the material-to-be-coated in the second surface region and that extends in the width direction of the conveyer; and a third main body and a fourth main body that extend in the width direction of the conveyer,
the second ejection port is formed between the third main body and the fourth main body,
the second gas ejector is disposed such that: the second ejection port is in a vicinity of the second discharge port; and the third main body is disposed close to the second die head and the fourth main body is disposed close to the conveyer, and
the third main body extends closer to the second die head than the fourth main body does.

7. A coating method using the coating device according to claim 1, the method comprising:
continuously conveying the sheet-shaped material-to-be-coated while intermittently discharging the first slurry from the first die head toward the first surface region of the material-to-be-coated being continuously conveyed, to discontinuously form the first coated section.

8. A coating method using the coating device according to claim 5, the method comprising:
continuously conveying the sheet-shaped material-to-be-coated while intermittently discharging the first slurry from the first die head toward the first surface region of the material-to-be-coated being continuously conveyed, to discontinuously form the first coated section; and
intermittently discharging the second slurry from the second die head toward the second surface region of the material-to-be-coated being continuously conveyed, to discontinuously form the second coated section.

9. A method of manufacturing a positive electrode through the coating method according to claim 8, the method comprising:
using a positive electrode current collector as the material-to-be-coated;
using a slurry for a positive electrode mixture layer as the first slurry; and
using a slurry for an insulating layer as the second slurry.

10. A method of manufacturing a solid-state battery, the method comprising:
obtaining a positive electrode through the method of manufacturing a positive electrode according to claim 9.
